(19) United States
(12) Patent Application Publication
(10) Pub. No.: US 2025/0249809 A1
(43) Pub. Date: Aug. 7, 2025

(54) SEAT ASSEMBLY AND OFF-ROAD VEHICLE

(71) Applicant: KAWASAKI MOTORS, LTD., Hyogo (JP)

(72) Inventor: Akihiro FUKUMOTO, Akashi-shi (JP)

(73) Assignee: KAWASAKI MOTORS, LTD., Hyogo (JP)

(21) Appl. No.: 19/005,867

(22) Filed: Dec. 30, 2024

Related U.S. Application Data
(63) Continuation-in-part of application No. 18/434,975, filed on Feb. 7, 2024.

(51) Int. Cl. B60N 2/68; B60N 2/06; B60R 22/02; B60R 22/26

(52) U.S. Cl. CPC B60N 2/688; B60N 2/06; B60R 22/26; B60R 2022/027

(57) ABSTRACT

A seat assembly 10 is attached to a vehicle body frame 1, and includes a seat cushion 13a, a support 30, 30A supporting the seat cushion 13a and attached to the vehicle body frame 1 so as to move in a front-rear direction, and a seatbelt 20 having a side belt 21. The side belt 21 is attached to the support 30, 30A.

### CROSS-REFERENCE TO RELATED APPLICATION

This application is Continuous in Part of U.S. patent application Ser. No. 18/434,975 filed on Feb. 7, 2024, the entirety of which is incorporated herein by reference.

### FIELD

The technique disclosed here relates to a seat assembly and an off-road vehicle.

### BACKGROUND

FIG. 47 of U.S. Patent Application Publication No. 2021/0206438 shows a seat assembly. The seat assembly has a seat attached to a vehicle body frame so as to move in a front-rear direction and a seatbelt securing an occupant in the seat. The seatbelt is a six-point seatbelt, and includes a side belt corresponding to a side portion of the abdomen of the occupant. The side belt is fixed to the vehicle body frame in rear of the seat.

### SUMMARY

In the seat assembly as described above, the side belt is fixed to the vehicle body frame in rear of the seat, and therefore, does not follow movement of the seat when the occupant moves the seat forward. For this reason, there is a probability that the side portion of the abdomen of the occupant is excessively tightened with the side belt.

The technique disclosed here has been made in view of the above-described point, and an object thereof is to reduce excessive tightening of the side portion of the abdomen of the occupant.

The seat assembly disclosed here is a seat assembly attached to a vehicle body frame, which includes a seat cushion, a support supporting the seat cushion and attached to the vehicle body frame so as to move in a front-rear direction, and a seatbelt having a side belt. The side belt is attached to the support.

The off-road vehicle disclosed here is an off-road vehicle including a vehicle body frame, and a seat assembly attached to the vehicle body frame. The seat assembly includes a seat cushion, a support supporting the seat cushion and attached to the vehicle body frame so as to move in a front-rear direction, and a seatbelt including a side belt. The side belt is attached to the support.

The above-described seat assembly can reduce excessive tightening of the side portion of the abdomen of the occupant.

The above-described off-road vehicle can reduce excessive tightening of the side portion of the abdomen of the occupant.

### BRIEF DESCRIPTION OF THE DRAWINGS

FIG. 1 is a left side view of a utility vehicle according to a first embodiment.

FIG. 2 is a side view of a left front seat assembly from a vehicle-width outside.

FIG. 3 is a perspective view of the left front seat assembly from the front.

FIG. 4 is an enlarged side view of the left front seat assembly from the vehicle-width outside.

FIG. 5 is an enlarged plan view of the left front seat assembly from above.

FIG. 6 is a schematic front view of a slide adjuster from the front.

FIG. 7 is a schematic front view of a reclining adjuster from the front.

FIG. 8 is a schematic side view of a lift adjuster from the vehicle-width outside.

FIG. 9 is a schematic side view of the lift adjuster from a vehicle-width inside.

FIG. 10 is a schematic side view showing a state of a seat frame being moved upward by the lift adjuster.

FIG. 11 is a schematic plan view of a seat assembly according to a first modification.

FIG. 12 is a schematic plan view of a seat assembly according to a second modification.

FIG. 13 is an enlarged side view showing, from the outside in a width direction, a left front seat assembly in a utility vehicle according to a second embodiment.

FIG. 14 is a perspective view showing the left front seat assembly from the front.

FIG. 15 is a schematic sectional view showing a portion of a seating frame to which an attachment portion is attached.

FIG. 16 is a schematic front view showing a left lower front portion of the seating frame from the front.

FIG. 17 is a schematic perspective view showing a left lower rear portion of the seating frame from the front.

FIG. 18 is a schematic perspective view showing a left lower rear portion of the seating frame from the right front.

### DESCRIPTION OF EMBODIMENTS

Hereinafter, an exemplary embodiment will be described in detail with reference to the drawings.

### First Embodiment

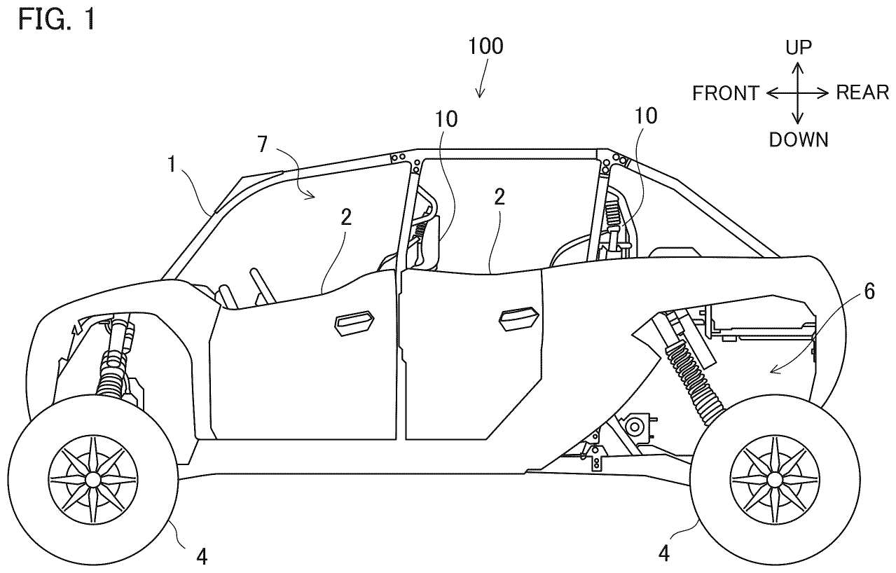

FIG. 1 is a left side view of a utility vehicle 100. The utility vehicle 100 can travel off road. The utility vehicle 100 is one example of an off-road vehicle. Hereinafter, the utility vehicle 100 will also be merely referred to as a “vehicle 100.”

In the present disclosure, each component of the vehicle 100 will be described using a direction with respect to the vehicle 100. Specifically, a “front” means the front of the vehicle 100 in a vehicle front-rear direction, and a “rear” means the rear of the vehicle 100 in the vehicle front-rear direction. A “left” means the left when facing the front of the vehicle 100, and a “right” means the right when facing the front of the vehicle 100. A “width direction” means the vehicle width direction of the vehicle 100, and in other words, means the right-left direction of the vehicle 100 and will also be referred to as a “right-left direction.” A “vehicle-width inside” means a vehicle interior side in the width direction, and a “vehicle-width outside” means a vehicle outer side in the width direction. Each direction with respect to a seat assembly 10 is coincident with a corresponding direction with respect to the vehicle 100 when the seat assembly 10 is incorporated into the vehicle 100. For example, the front-rear direction of the seat assembly 10 is coincident with the front-rear direction of the vehicle 100 when the seat assembly 10 is incorporated into the vehicle 100.

The vehicle 100 includes a vehicle body frame 1 and the seat assembly 10. The vehicle 100 further includes a door 2 and a wheel 4. A vehicle interior 7 is defined in the vehicle body frame 1. The seat assembly 10 includes a front seat assembly (front seat) and a rear seat assembly (rear seat). The door 2 includes a front door and a rear door. The wheel 4 includes right and left front wheels and right and left rear wheels. That is, the vehicle 100 is a four-wheeled vehicle. An engine room 6 is located in rear of the vehicle body frame 1, specifically in rear of the rear seat. The engine room 6 houses a power unit. The power unit has, for example, an engine, a transmission that changes an output engine speed, a power generator that generates power with the power of the engine, and a battery that stores the power generated by the power generator.

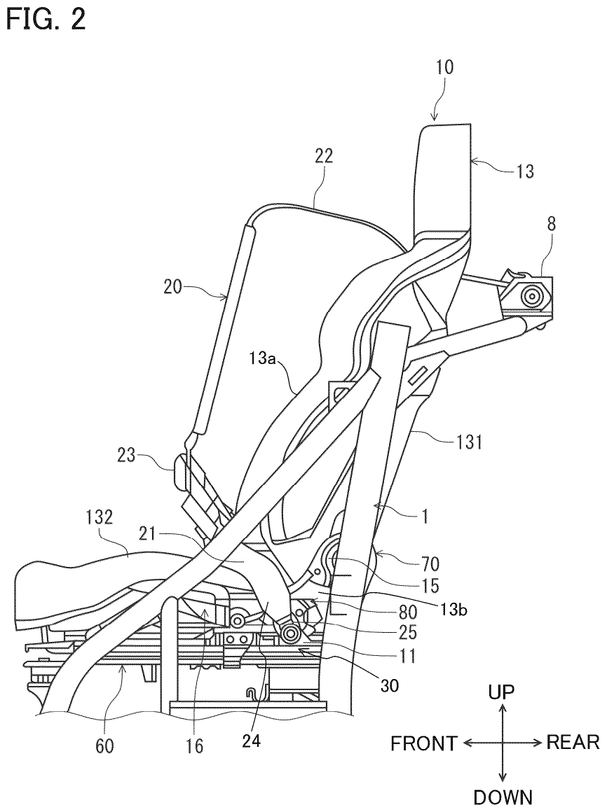

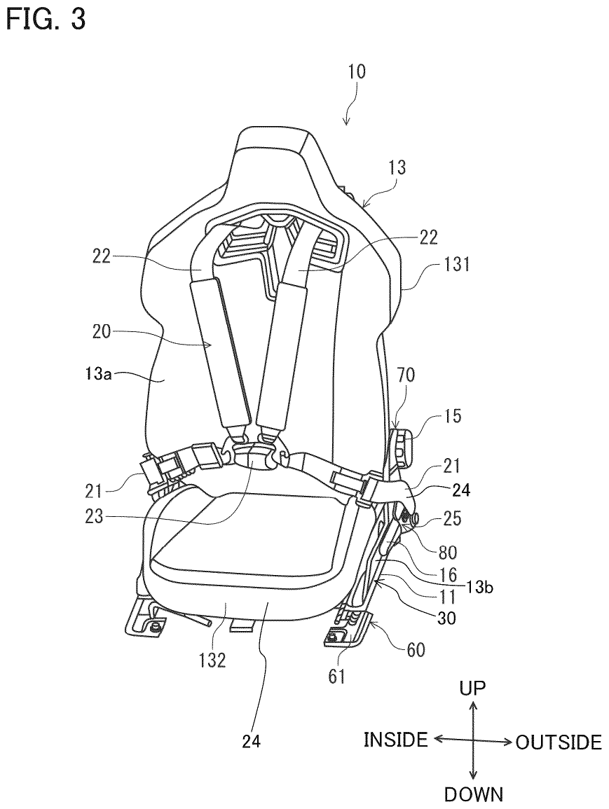

FIG. 2 is a side view of the left front seat assembly 10 from the vehicle-width outside. FIG. 3 is a perspective view of the left front seat assembly 10 from the front.

The seat assembly 10 is attached to the vehicle body frame 1. The seat assembly 10 includes a seat cushion 13a, a support 30 supporting the seat cushion 13a and attached to the vehicle body frame 1 so as to move in the front-rear direction, and a seatbelt 20 including a side belt 21. Specifically, the seat assembly 10 includes a slide frame 11 attached to the vehicle body frame 1 so as to move in the front-rear direction, a seat 13 attached to the slide frame 11, and the seatbelt 20 securing an occupant in the seat 13. The seat 13 includes the seat cushion 13a and a seating frame 13b supporting the seat cushion 13a. The seating frame 13b is attached to the slide frame 11. The support 30 includes the seating frame 13b and the slide frame 11.

The seat cushion 13a of the seat 13 has a back portion 131 supporting the back of the occupant and a seat portion 132 supporting the hip of the occupant. A hole penetrating the back portion 131 back and forth is located in an upper portion of the back portion 131.

In this embodiment, the seatbelt 20 is a four-point seatbelt. Specifically, the seatbelt 20 has two side belts 21 corresponding to the side portions of the abdomen of the occupant, two shoulder belts 22 corresponding to the shoulders of the occupant, and a buckle 23 coupling the side belts 21 and the shoulder belts 22 to each other. The buckle 23 has an internal portion to be connected to a first end portion of the left side belt 21 and a first end portion of the left shoulder belt 22 and an external portion to be connected to a first end portion of the right side belt 21 and a first end portion of the right shoulder belt 22. The external portion is inserted into and locked to the internal portion. A press button is disposed at the internal portion, and by pressing the press button, the external portion can be detached from the internal portion.

The side belt 21 is attached to the support 30. That is, the side belt 21 is attached to the slide frame 11. Specifically, the seatbelt 20 includes an attachment portion 25 attaching the side belt 21 to the slide frame 11. Specifically, the side belt 21 includes a belt portion 24 and the attachment portion 25 connected to an end portion of the belt portion 24. The attachment portion 25 is, for example, a metal fitting. A second end portion of the side belt 21 is the attachment portion 25, and the attachment portion 25 is tied with the end portion of the attachment portion 25. The attachment portion 25 is attached, with a screw, to a rear portion of the slide frame 11. FIGS. 2 and 3 show the attachment portion 25 connected to the belt portion 24 of the left side belt 21. The same also applies to the attachment portion 25 connected to the belt portion 24 of the right side belt 21, and such an attachment portion 25 is attached to the slide frame 11.

The shoulder belt 22 is inserted into the hole in the upper portion of the back portion 131, and a second end portion of the shoulder belt 22 is attached to the vehicle body frame 1. Specifically, the second end portion of the shoulder belt 22 is connected to a belt winder 8 attached to the vehicle body frame 1. The belt winder 8 winds and unwinds the shoulder belt 22. The belt winder 8 fixes the shoulder belt 22 such that the shoulder belt 22 is not unwound upon collision. FIG. 2 shows the belt winder 8 connected to the left shoulder belt 22, and the same also applies to a belt winder 8 connected to the right shoulder belt 22.

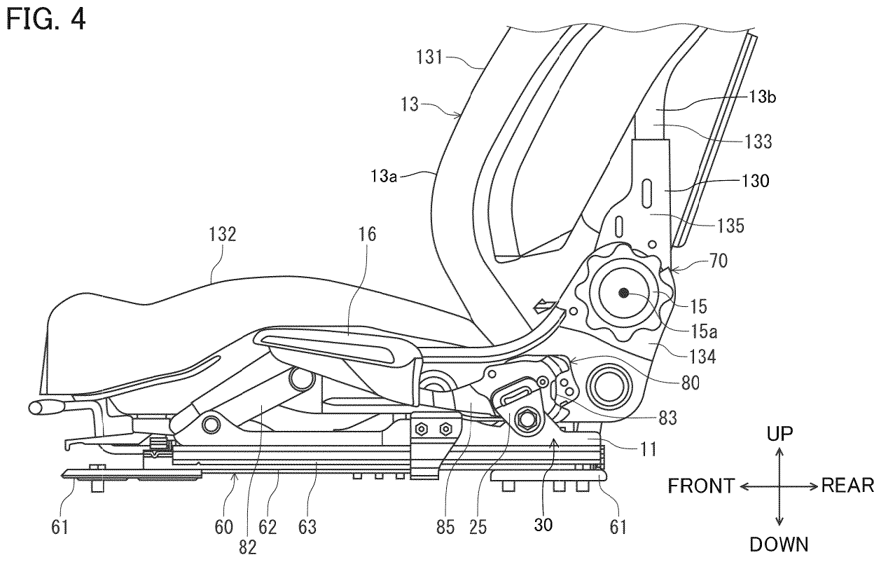

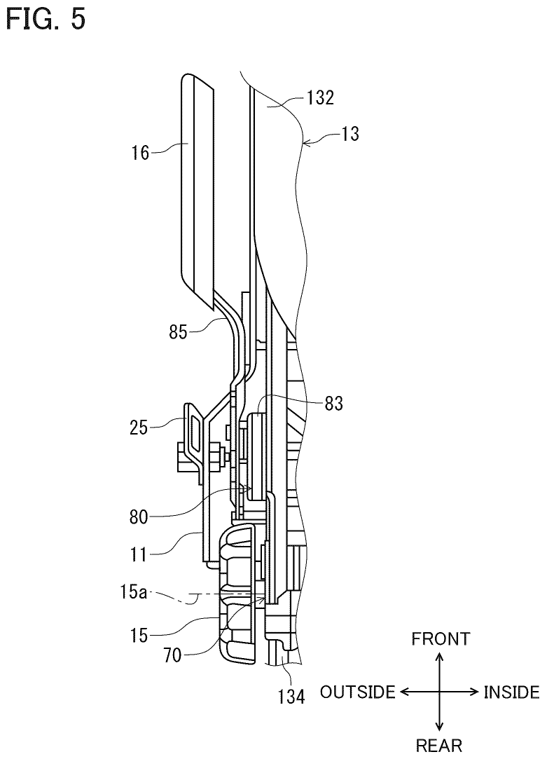

FIG. 4 is an enlarged side view of the left front seat assembly 10 from the vehicle-width outside. FIG. 5 is an enlarged plan view of the left front seat assembly 10 from above.

The seating frame 13b of the seat 13 includes a seating frame body 130. The seating frame body 130 has a back frame 133, a seat frame 134, and a coupling portion 135. The back frame 133 supports the back portion 131. The seat frame 134 supports the seat portion 132. The coupling portion 135 couples the back frame 133 and the seat frame 134 to each other. The coupling portion 135 is disposed on each side in the width direction. The seat frame 134 is attached to the slide frame 11.

The seat assembly 10 has a slide adjuster 60, a reclining adjuster 70, and a lift adjuster 80.

The slide adjuster 60 attaches the slide frame 11 to the vehicle body frame 1 such that the slide frame 11 is movable in the front-rear direction. That is, the slide frame 11 is attached to the vehicle body frame 1 through the slide adjuster 60.

The reclining adjuster 70 tilts the seat 13 back and forth. Specifically, the reclining adjuster 70 tilts the back portion 131 of the seat 13 back and forth. The reclining adjuster 70 is attached to the seat frame 134, and is movable relative to the vehicle body frame 1.

The lift adjuster 80 moves the seat 13 up and down. The lift adjuster 80 is attached to the seat frame 134, and is movable relative to the vehicle body frame 1. Note that the lift adjuster 80 may move only the seat portion 132 of the seat 13 up and down.

The seat assembly 10 has a reclining operator 15 and a lift operator 16. The reclining operator 15 operates the reclining adjuster 70, thereby performing an operation of tilting the back portion 131 of the seat 13 back and forth. The reclining operator 15 is a portion to be gripped by the occupant. The reclining operator 15 is a circular columnar dial operator. The reclining operator 15 includes a center 15a extending in the width direction.

The lift operator 16 operates the lift adjuster 80, thereby performing an operation of moving the seat 13 up and down. The lift operator 16 is a portion to be gripped by the occupant. The lift operator 16 is positioned in front with respect to the reclining operator 15. The lift operator 16 is a rod-shaped lever operator. The lift operator 16 extends in the front-rear direction.

The reclining operator 15 and the lift operator 16 are positioned on the vehicle-width outside of the seat assembly 10. Specifically, the reclining operator 15 and the lift operator 16 are positioned on the vehicle-width outside of the seat frame 134.

The attachment portion 25 is positioned in front with respect to the reclining operator 15. Specifically, the attachment portion 25 is positioned between the reclining operator 15 and the lift operator 16 in the front-rear direction. The attachment portion 25 is positioned on the vehicle-width outside of the seat frame 134. The lift operator 16 is positioned higher than the attachment portion 25. The reclining operator 15 is positioned higher than the lift operator 16.

The attachment portion 25 is positioned on the vehicle-width outside of the lift adjuster 80 as viewed from above. That is, the attachment portion 25 is positioned, as viewed from above, on the same line as that of the lift adjuster 80 in the width direction. Specifically, at the lowermost position of the seat 13 adjusted by the lift adjuster 80, the attachment portion 25 overlaps with the lift adjuster 80 as viewed in the width direction. Specifically, the attachment portion 25 overlaps with a torque transmitter 83 of the lift adjuster 80. FIGS. 3 and 4 show the lowermost position of the seat 13 (specifically, seat portion 132) adjusted by the lift adjuster 80.

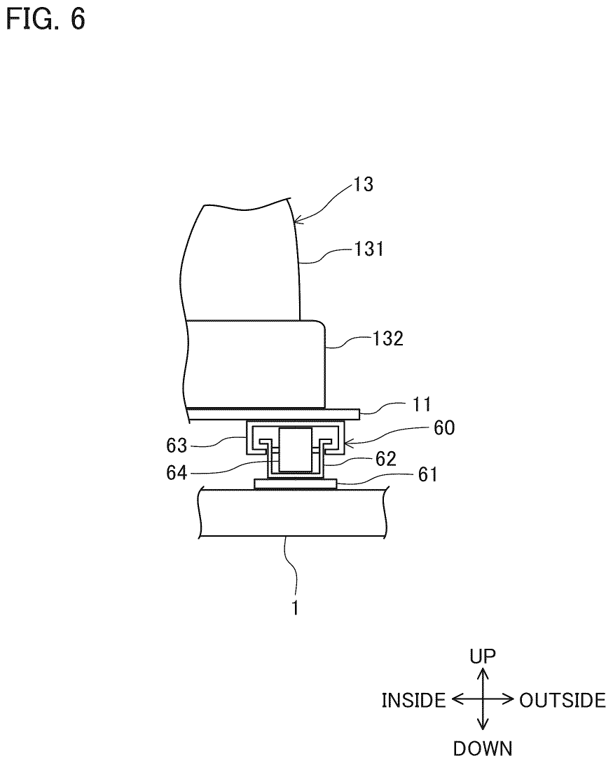

FIG. 6 is a schematic front view of the slide adjuster 60 from the front. FIG. 6 shows the slide adjuster 60 on the vehicle-width outside of the seat assembly 10. The slide adjuster 60 having a similar configuration is also disposed on the vehicle-width inside of the seat assembly 10. The slide adjuster 60 has a bracket 61, a rail 62, a guide 63, and a roller 64. Note that the slide adjuster 60 is not limited to this configuration and is only required to slide the slide frame 11 relative to the vehicle body frame 1.

The bracket 61 is fixed to the vehicle body frame 1. The rail 62 extends in the front-rear direction, and is fixed to the bracket 61. The guide 63 extends in the front-rear direction, and is fitted onto the rail 62. The roller 64 is located between the rail 62 and the guide 63, and is rotatably attached to the rail 62. The guide 63 is supported by the roller 64. With this configuration, the guide 63 is moved in the front-rear direction by the roller 64 while being guided by the rail 62.

The slide frame 11 is fixed onto the guide 63. With this configuration, the slide frame 11 is movable in the front-rear direction relative to the vehicle body frame 1. That is, the seat 13 (specifically, seat frame 134) attached to the slide frame 11 is movable in the front-rear direction relative to the vehicle body frame 1. Note that although not shown in the figure, the slide adjuster 60 has a seat lock fixing the position of the seat 13 in the front-rear direction.

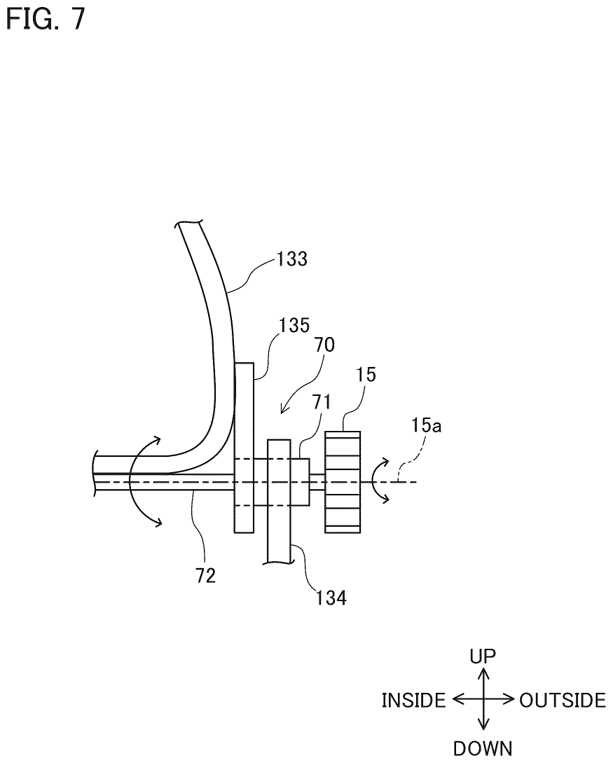

FIG. 7 is a schematic front view of the reclining adjuster 70 from the front. In FIG. 7, the back portion 131 is omitted. The reclining adjuster 70 has a gear transmitter 71 and a rod 72.

The gear transmitter 71 is attached to the seat frame 134. The gear transmitter 71 is connected to the coupling portion 135. The reclining operator 15 is attached to the gear transmitter 71. The rod 72 extends in the width direction, and is coupled to the coupling portions 135 on both sides in the width direction.

The gear transmitter 71 has an internal gear and an external gear engaging with each other, and transmits rotation of the reclining operator 15 to the coupling portions 135. Thus, when the reclining operator 15 rotates about the center 15a, the back frame 133 rotates about the center 15a through the coupling portions 135 on both sides in the width direction. That is, the back portion 131 is tiltable back and forth.

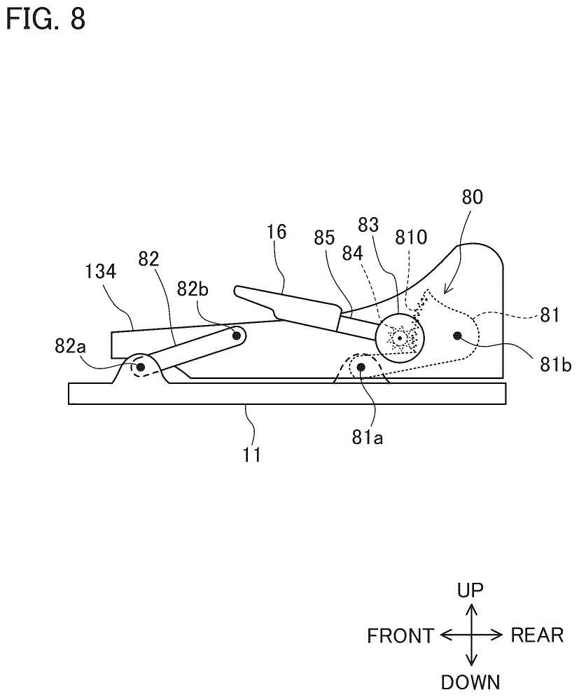

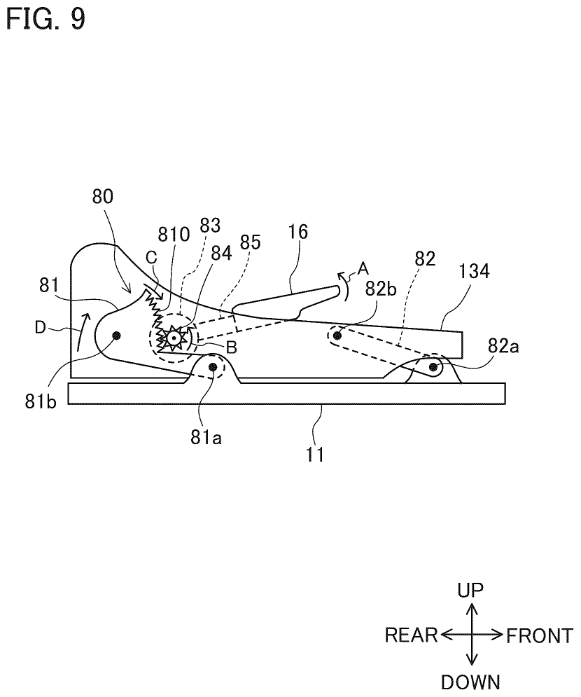

FIG. 8 is a schematic side view of the lift adjuster 80 from the vehicle-width outside. FIG. 9 is a schematic side view of the lift adjuster 80 from the vehicle-width inside. The lift adjuster 80 has a first link 81, a second link 82, the torque transmitter 83, and a pinion gear 84.

The first link 81 is positioned in rear with respect to the second link 82. The first link 81 is positioned on the vehicle-width inside of the seat frame 134. The first link 81 is coupled to the slide frame 11 at a first support point 81a, and is coupled to the seat frame 134 at a second support point 81b. The first link 81 has a lifter gear 810 at an end portion on the second support point 81b side.

The second link 82 is positioned on the vehicle-width outside of the seat frame 134. The second link 82 is coupled to the slide frame 11 at a first support point 82a, and is coupled to the seat frame 134 at a second support point 82b. With this configuration, the seat frame 134 is movable up and down relative to the slide frame 11 through the first link 81 and the second link 82.

The torque transmitter 83 is attached to the seat frame 134. The lift operator 16 is connected to an input shaft of the torque transmitter 83 through a coupling bar 85. The pinion gear 84 is connected to an output shaft of the torque transmitter 83. The pinion gear 84 is positioned on the vehicle-width inside of the seat frame 134, and engages with the lifter gear 810 of the first link 81. The torque transmitter 83 has a clutch structure, and transmits torque from the input shaft side to the output shaft side and does not transmit torque from the output shaft side to the input shaft side. The torque transmitter 83 has such a ratchet structure that only rotative force obtained by turn of the lift operator 16 in one arbitrarily-selected direction can be output. That is, the torque transmitter 83 can output rotative force in one arbitrary direction by repeated reciprocating rotation of the lift operator 16.

Subsequently, the features of the lift adjuster 80 will be described.

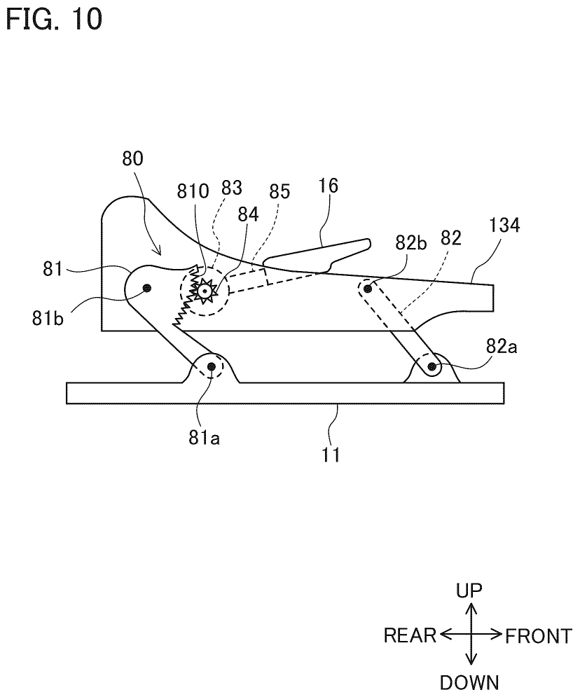

In a case of lifting the seat frame 134 (i.e., seat 13), the lift operator 16 is operated in the upward direction indicated by an arrow A. The pinion gear 84 moves in conjunction with operation of the lift operator 16 through the torque transmitter 83, and rotates in the direction of an arrow B which is the same direction as the direction of the arrow A. The lifter gear 810 rotates in conjunction with movement of the pinion gear 84 in the direction of an arrow C which is the opposite direction of the direction of the arrow B. That is, the first link 81 rotates about the first support point 81a in the direction of an arrow D. Accordingly, as shown in FIG. 10, the seat frame 134 moves upward about the first support point 81a of the first link 81 and the first support point 82a of the second link 82.

In a case of lowering the seat frame 134 (i.e., seat 13), the lift operator 16 is operated in the downward direction opposite to the direction of the arrow A. The pinion gear 84 rotates in the opposite direction of the direction of the arrow B. The lifter gear 810 rotates in the opposite direction of the direction of the arrow C. That is, the first link 81 rotates about the first support point 81a in the opposite direction of the direction of the arrow D. Accordingly, as shown in FIG. 9, the seat frame 134 moves downward about the first support point 81a of the first link 81 and the first support point 82a of the second link 82.

According to the above-described seat assembly 10, the side belt 21 of the seatbelt 20 is attached to the slide frame 11 (support 30), and therefore, the side belt 21 moves so as to follow movement of the seat 13 when the occupant moves the seat 13 forward through the slide adjuster 60. Thus, upon forward movement of the seat 13, the side portion of the abdomen of the occupant is less likely to be excessively tightened with the side belt 21, and excessive tightening of the side portion of the abdomen of the occupant can be reduced.

The attachment portion 25 is positioned in front with respect to the reclining operator 15, and therefore, contact between the side belt 21 and the reclining operator 15 can be prevented and the reclining operator 15 can be favorably operated.

The attachment portion 25 is positioned between the lift operator 16 and the reclining operator 15 in the front-rear direction, and therefore, contact of the side belt 21 with the lift operator 16 and the reclining operator 15 can be prevented and the lift operator 16 and the reclining operator 15 can be favorably operated.

The reclining operator 15 is the dial operator, and therefore, can be reduced in size.

The attachment portion 25 is positioned on the vehicle-width outside of the lift adjuster 80 as viewed from above, and therefore, the dimension of the seat assembly 10 in the front-rear direction can be reduced.

According to the above-described vehicle 100, the side belt 21 of the seatbelt 20 is attached to the slide frame 11 (support 30), and therefore, follows movement of the seat 13 when the occupant moves the seat 13 forward. Thus, upon forward movement of the seat 13, the side portion of the abdomen of the occupant is less likely to be excessively tightened with the side belt 21, and excessive tightening of the side portion of the abdomen of the occupant can be reduced.

### First Modification

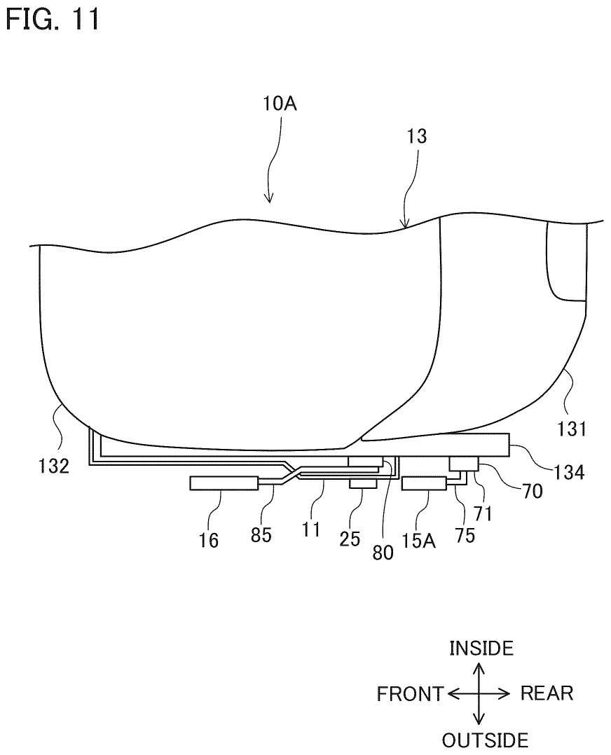

FIG. 11 is a schematic plan view of a seat assembly 10A according to a first modification. The seat assembly 10A according to the first modification is different from the seat assembly 10 according to the first embodiment in the configuration of a reclining operator 15A. Hereinafter, a different configuration of the seat assembly 10A according to the first modification from that of the seat assembly 10 according to the first embodiment will be mainly described. Note that in the seat assembly 10A according to the first modification, the same reference numerals as those of the seat assembly 10 according to the first embodiment represent the same components as those of the seat assembly 10 according to the first embodiment, and therefore, description thereof will be omitted.

In the seat assembly 10A according to the first modification, the reclining operator 15A is a rod-shaped lever operator. The reclining operator 15A extends in the front-rear direction. The reclining operator 15A is attached to the gear transmitter 71 through a coupling bar 75.

The reclining operator 15A, the lift operator 16, and the attachment portion 25 are linearly located in the front-rear direction as viewed from above. That is, the reclining operator 15A, the lift operator 16, and the attachment portion 25 are positioned on the same line in the front-rear direction as viewed from above.

The reclining operator 15A, the lift operator 16, and the attachment portion 25 are located at different heights in an up-down direction. The reclining operator 15A, the lift operator 16, and the attachment portion 25 may be located at the same height in the up-down direction.

According to the seat assembly 10A of the first modification, the reclining operator 15A, the lift operator 16, and the attachment portion 25 are linearly located in the front-rear direction as viewed from above, and therefore, the dimension of the seat assembly 10A in the width direction can be reduced.

Note that although description of other configurations, features, and effects will be omitted, description of the seat assembly 10 according to the first embodiment can be used in description of the seat assembly 10A according to the first modification.

### Second Modification

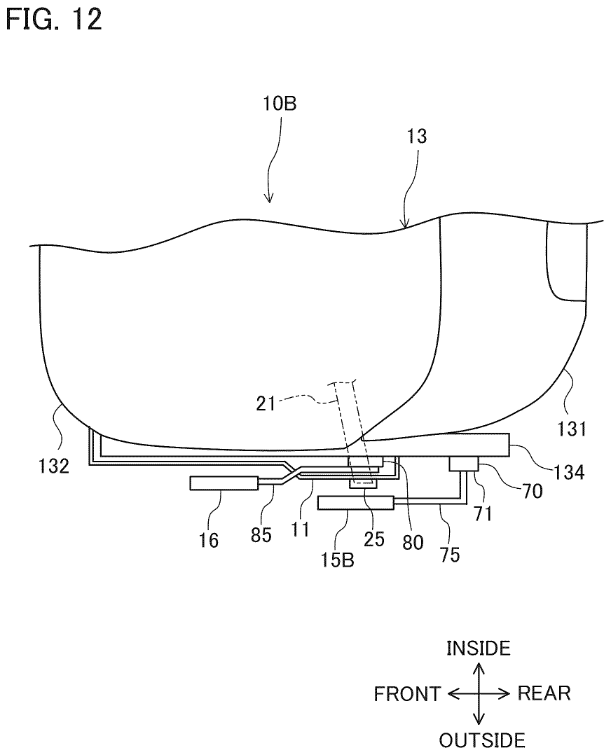

FIG. 12 is a schematic plan view of a seat assembly 10B according to a second modification. The seat assembly 10B according to the second modification is different from the seat assembly 10 according to the first embodiment in the configuration of a reclining operator 15B. Hereinafter, a different configuration of the seat assembly 10B according to the second modification from that of the seat assembly 10 according to the first embodiment will be mainly described. Note that in the seat assembly 10B according to the second modification, the same reference numerals as those of the seat assembly 10 according to the first embodiment represent the same components as those of the seat assembly 10 according to the first embodiment, and therefore, description thereof will be omitted.

In the seat assembly 10B according to the second modification, the reclining operator 15B is a rod-shaped lever operator. The reclining operator 15B extends in the front-rear direction. The reclining operator 15B is attached to the gear transmitter 71 through a coupling bar 75.

The attachment portion 25 is positioned on the vehicle-width inside with respect to the reclining operator 15B. Specifically, the attachment portion 25 is positioned on the vehicle-width inside of the reclining operator 15B as viewed from above. That is, the attachment portion 25 and the reclining operator 15B are positioned on the same line in the width direction as viewed from above.

The attachment portion 25 and the reclining operator 15B are located at different heights in the up-down direction. The attachment portion 25 and the reclining operator 15B may be located at the same height in the up-down direction.

According to the seat assembly 10B of the second modification, the attachment portion 25 is positioned on the vehicle-width inside with respect to the reclining operator 15B, and therefore, contact between the side belt 21 and the reclining operator 15B can be prevented and the reclining operator 15B can be favorably operated. Moreover, while contact between the side belt 21 and the reclining operator 15B is avoided, the reclining operator 15B can be extended to the vicinity of a hand of the occupant and the operability of the reclining operator 15B can be improved.

Note that although description of other configurations, features, and effects will be omitted, description of the seat assembly 10 according to the first embodiment can be used in description of the seat assembly 10B according to the second modification.

### Second Embodiment

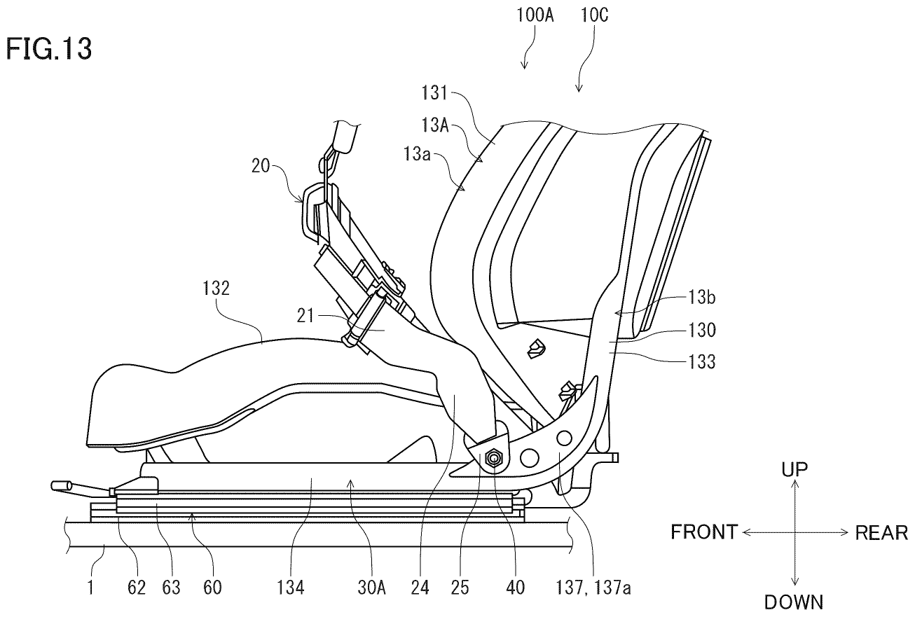

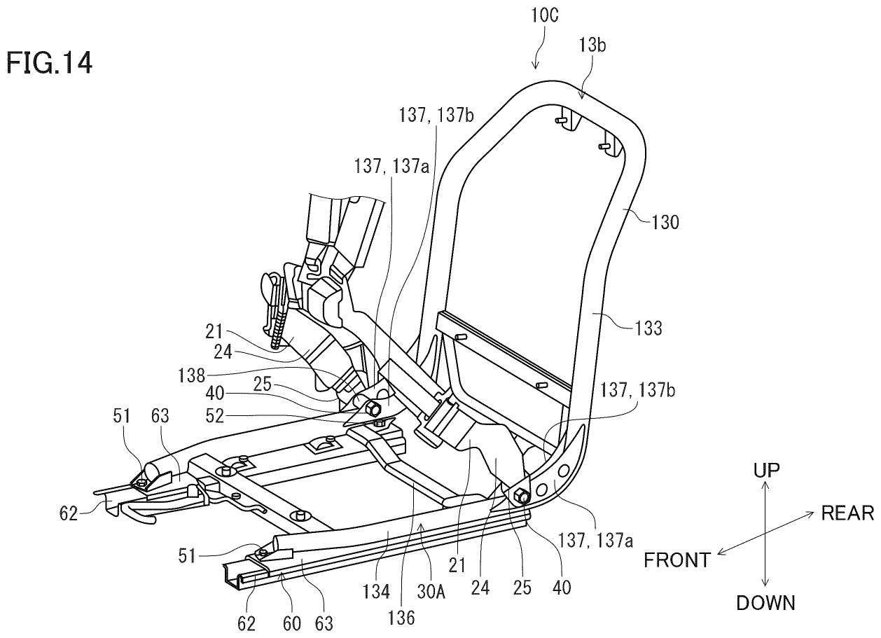

FIG. 13 is an enlarged side view of a left front seat assembly 10C of a utility vehicle 100A according to a second embodiment from the vehicle-width outside. FIG. 14 is a perspective view of the left front seat assembly 10C from the front.

The seat assembly 10C according to the second embodiment is different from the seat assembly 10 according to the first embodiment mainly in the configurations of a seat 13A and a support 30A and in that a reclining adjuster 70 and a lift adjuster 80 are not disposed. Hereinafter, a different configuration of the seat assembly 10C according to the second embodiment from the seat assembly 10 according to the first embodiment will be mainly described. Note that in the seat assembly 10C according to the second embodiment, the same reference numerals as those of the seat assembly 10 according to the first embodiment represent the same components as those of the seat assembly 10 according to the first embodiment, and therefore, description thereof will be omitted.

The seat 13A includes a seat cushion 13a and a seating frame 13b supporting the seat cushion 13a. The support 30A includes the seating frame 13b. The seat assembly 10C does not include a slide frame 11. A side belt 21 is attached to the support 30A, specifically the seating frame 13b.

The seating frame 13b includes a seating frame body 130 and a reinforcing portion 137 reinforcing the seating frame body 130. The seating frame body 130 is in a frame shape. The seating frame body 130 has a back frame 133 and a seat frame 134. The back frame 133 is attached to the seat frame 134. The seating frame body 130 further has a cross member 136. The cross member 136 is joined to the inside of the seat frame 134, and extends in the width direction. The cross member 136 has a recess for supporting the hip of an occupant and lowering the seating position of the occupant.

The reinforcing portion 137 is joined to the back frame 133 and the seat frame 134. The reinforcing portion 137 holds the strength of the seating frame body 130 in the direction of a backrest. The reinforcing portion 137 is joined to the back frame 133 and the seat frame 134, for example, by welding. The reinforcing portion 137 is in a plate shape, but may be in a frame shape.

The reinforcing portion 137 includes a first reinforcing portion 137a located outside the frame of the seating frame body 130, and a second reinforcing portion 137b disposed inside the frame of the seating frame body 130. The first reinforcing portion 137a and the second reinforcing portion 137b have the substantially same shape.

The first reinforcing portion 137a is joined to the outer surface of the seating frame body 130 in the width direction. The first reinforcing portion 137a is joined over a portion extending from a portion of the back frame 133 in the vicinity of the seat frame 134 to a portion of the seat frame 134 in the vicinity of the back frame 133.

The second reinforcing portion 137b is joined to the inner surface of the seating frame body 130 in the width direction. The second reinforcing portion 137b is joined over a portion extending from a portion of the back frame 133 in the vicinity of the seat frame 134 to a portion of the seat frame 134 in the vicinity of the back frame 133.

Hereinafter, in a case where the first reinforcing portion 137a and the second reinforcing portion 137b are not distinguished from each other, these portions will be merely referred to as a “reinforcing portion(s) 137.”

An attachment portion 25 is attached to the reinforcing portion 137. Part of the attachment portion 25 is located higher than the seat frame 134. The attachment portion 25 is located outside the frame of the seating frame body 130.

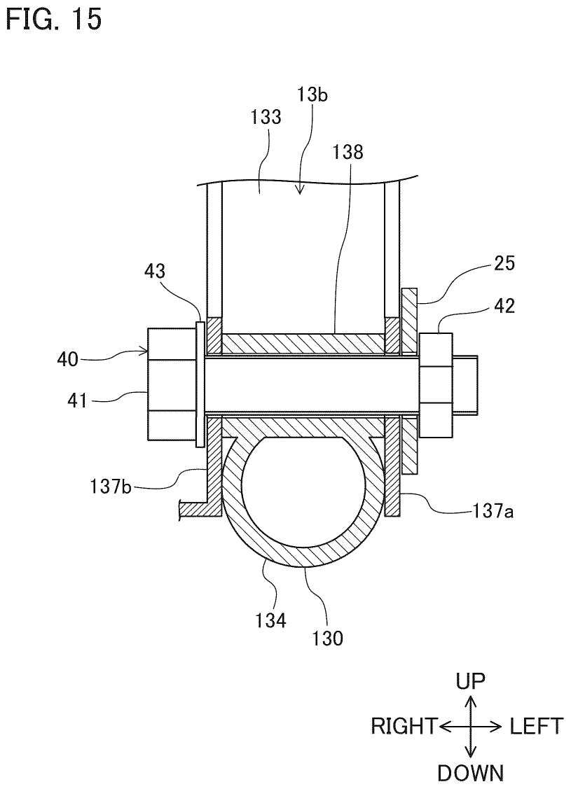

FIG. 15 is a schematic sectional view showing a portion of the seating frame 13b to which the attachment portion 25 is attached. FIG. 15 shows the attachment portion 25 of the left side belt 21. The attachment portion 25 is fastened to the reinforcing portion 137 with a fastening portion 40. The fastening portion 40 penetrates the first reinforcing portion 137a and the second reinforcing portion 137b, and fastens the attachment portion 25 to the first reinforcing portion 137a and the second reinforcing portion 137b. The attachment portion 25 is located on the side opposite to the seating frame body 130 with respect to the first reinforcing portion 137a.

The fastening portion 40 includes a bolt 41, a nut 42, and a washer 43. The first reinforcing portion 137a and the second reinforcing portion 137b are coupled to each other through a tubular portion 138. The tubular portion 138 is integrated with the seat frame 134. The bolt 41 penetrates the first reinforcing portion 137a, the second reinforcing portion 137b, and the tubular portion 138. A head portion of the bolt 41 is located on the second reinforcing portion 137b side. The washer 43 is sandwiched between the head portion of the bolt 41 and the second reinforcing portion 137b. The nut 42 is located on the first reinforcing portion 137a side. The nut 42 is screwed onto the bolt 41. The bolt 41 penetrates the attachment portion 25, and the attachment portion 25 is sandwiched and held between the first reinforcing portion 137a and the nut 42.

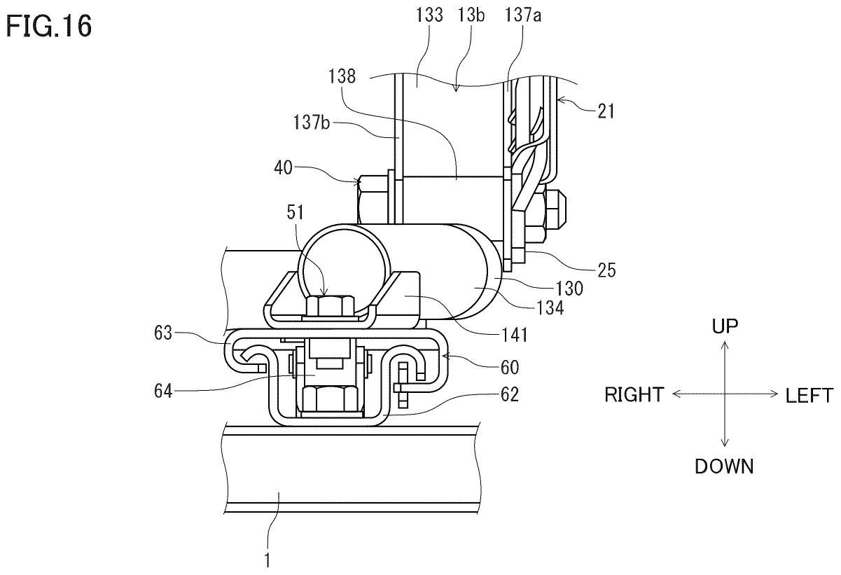

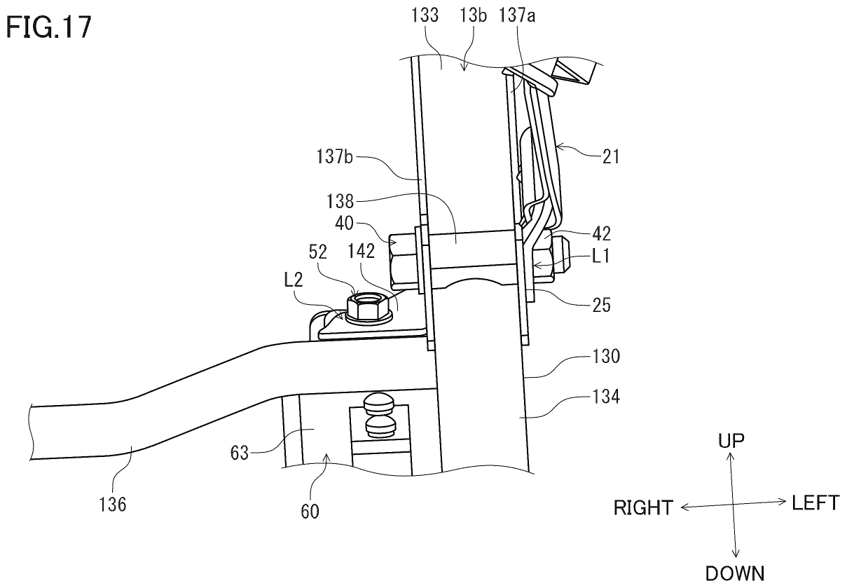

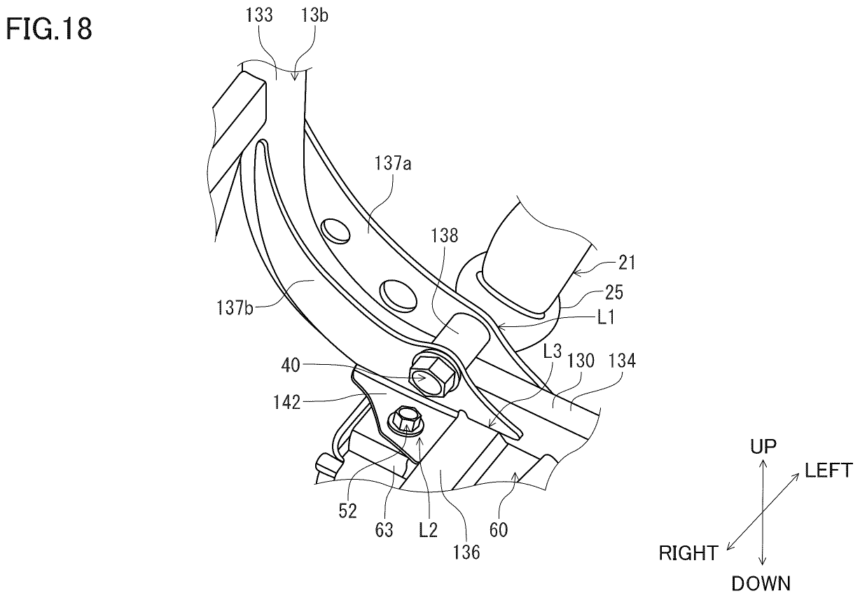

FIG. 16 is a schematic front view showing a left lower front portion of the seating frame 13b from the front. FIG. 17 is a schematic perspective view showing a left lower rear portion of the seating frame 13b from the front. FIG. 18 is a schematic perspective view showing a left lower rear portion of the seating frame 13b from the right front.

A slide adjuster 60 has a rail 62, a guide 63, and a roller 64. The rail 62 is fixed to a vehicle body frame 1. The guide 63 is attached to the rail 62 so as to move in the front-rear direction. The guide 63 is fitted in the rail 62. The roller 64 is located between the rail 62 and the guide 63, and is rotatably attached to the rail 62. The guide 63 is supported by the roller 64. With this configuration, the guide 63 is moved in the front-rear direction by the roller 64 while being guided by the rail 62.

The seating frame 13b is joined to the guide 63. Specifically, a lower front portion of the seating frame 13b is fastened to the guide 63 with a fastening portion 51. A lower rear portion of the seating frame 13b is fastened to the guide 63 with a fastening portion 52. Each of the fastening portions 51, 52 includes a bolt, a nut, and a washer.

As shown in FIG. 16, the lower front portion of the seating frame 13b includes a bracket 141 connected to the front end of the seat frame 134. The bracket 141 is fastened to the guide 63 with the fastening portion 51. Specifically, the bolt of the fastening portion 51 penetrates the bracket 141 and the guide 63, and is screwed into the nut of the fastening portion 51.

As shown in FIGS. 17 and 18, the lower rear portion of the seating frame 13b includes a bracket 142 connected to the lower end of the second reinforcing portion 137b. The bracket 142 is fastened to the guide 63 with the fastening portion 52. Specifically, the bolt of the fastening portion 52 penetrates the bracket 142 and the guide 63, and is screwed into the nut of the fastening portion 52.

A position at which the attachment portion 25 is joined to the reinforcing portion 137 is in the vicinity of a position at which the seating frame 13b is joined to the guide 63. Moreover, the position at which the attachment portion 25 is joined to the reinforcing portion 137 and the position at which the seating frame 13b is joined to the guide 63 are in rear of the center position of the seat frame 134 in the front-rear direction. Hereinafter, the position at which the attachment portion 25 is joined to the reinforcing portion 137 will also be referred to as a first joint position L1, and the position at which the seating frame 13b is joined to the guide 63 will also be referred to as a second joint position L2.

The first joint position L1 is a position at which a portion of the attachment portion 25 is fastened to the reinforcing portion 137 with the fastening portion 40. Specifically, the first joint position L1 is the position of a portion of the attachment portion 25 sandwiched between the first reinforcing portion 137a and the nut 42.

The second joint position L2 is a position at which a portion of the seating frame 13b is fastened to the guide 63 with the fastening portion 52. Specifically, the second joint position L2 is the position of a portion of the bracket 142 sandwiched between the guide 63 and the fastening portion 52 (bolt in this case).

The first joint position L1 is positioned above the second joint position L2 as viewed in the width direction. Specifically, the first joint position L1 and the second joint position L2 are linearly located in the up-down direction as viewed in the width direction.

The position at which the attachment portion 25 is joined to the reinforcing portion 137 is in the vicinity of a position at which the cross member 136 is joined to the seat frame 134. Moreover, the position at which the attachment portion 25 is joined to the reinforcing portion 137 and the position at which the cross member 136 is joined to the seat frame 134 are in rear of the center position of the seat frame 134 in the front-rear direction. Hereinafter, the position at which the cross member 136 is joined to the seat frame 134 will also be referred to as a third joint position L3.

Both end portions of the cross member 136 are joined to the inside of the seat frame 134 by welding. The third joint position L3 is a position at which a portion of the cross member 136 is joined to the seat frame 134 by welding. Specifically, the third joint position L3 is the position of an end portion of the cross member 136 welded to the seat frame 134. The first joint position L1 is above the third joint position L3 as viewed in the width direction.

According to the above-described seat assembly 10C, the side belt 21 of the seatbelt 20 is attached to the support 30A, and therefore, the side belt 21 moves so as to follow movement of the seat 13A when the occupant moves the seat 13A (seat cushion 13a) forward through the slide adjuster 60. Thus, upon forward movement of the seat 13A, the side portion of the abdomen of the occupant is less likely to be excessively tightened with the side belt 21, and excessive tightening of the side portion of the abdomen of the occupant can be reduced.

Moreover, the side belt 21 is attached to the seating frame 13b, and therefore, the seating frame 13b can be used for attachment of the side belt 21. Thus, a weight and cost increase can be suppressed without additionally disposing a component for attaching the side belt 21.

The attachment portion 25 is attached to the reinforcing portion 137, and therefore, the reinforcing portion 137 can be used for attachment of the attachment portion 25. Thus, a weight and cost increase can be suppressed without additionally disposing a component for attaching the attachment portion 25.

When the vehicle stops, even if the side belt 21 is pulled forward of the occupant due to inertia force, pull force acts on the 137, and is less likely to directly act on the seating frame body 130. Thus, a load on the seating frame body 130 due to the pull force can be reduced.

The position at which the attachment portion 25 is joined to the reinforcing portion 137 is in the vicinity of the position at which the seating frame 13b is joined to the guide 63, and therefore, the pull force is likely to be transmitted to the guide 63 through the attachment portion 25 and the reinforcing portion 137, and is less likely to directly act on the seating frame body 130. Thus, the load on the seating frame body 130 due to the pull force can be reduced.

The position at which the attachment portion 25 is joined to the reinforcing portion 137 and the position at which the seating frame 13b is joined to the guide 63 are in rear of the center position of the seat frame 134 in the front-rear direction, and therefore, the pull force is likely to be transmitted to the guide 63 through the attachment portion 25 and the reinforcing portion 137, and is less likely to directly act on the seating frame body 130. Thus, the load on the seating frame body 130 due to the pull force can be reduced.

The position at which the attachment portion 25 is joined to the reinforcing portion 137 is in the vicinity of the position at which the cross member 136 is joined to the seat frame 134, and therefore, even if the pull force acts inward of the seat frame 134 on the seat frame 134, the cross member 136 causes propping-up force (push force) to act on the seat frame 134. Thus, the propping-up force acts against the pull force, and a load on the seat frame 134 due to the pull force can be reduced.

The position at which the attachment portion 25 is joined to the reinforcing portion 137 and the position at which the cross member 136 is joined to the seat frame 134 are in rear of the center position of the seat frame 134 in the front-rear direction, and therefore, even if the pull force acts inward of the seat frame 134 on the seat frame 134, the cross member 136 causes the propping-up force to act on the seat frame 134. Thus, the propping-up force acts against the pull force, and the load on the seat frame 134 due to the pull force can be reduced.

The reinforcing portion 137 is joined to the seat frame 134 and the back frame 133, and therefore, the reinforcing portion 137 can hold the strength of the seating frame body 130 in the direction of the backrest.

Part of the attachment portion 25 is located higher than the seat frame 134, and therefore, the length of the belt portion 24 can be shortened.

The attachment portion 25 is located outside the frame of the seating frame body 130, and therefore, when the occupant sits on the seat, the occupant is less likely to contact the attachment portion 25, and narrowing of an occupant seating space can be suppressed.

The fastening portion 40 penetrates the first reinforcing portion 137a and the second reinforcing portion 137b and fastens the attachment portion 25 to the first reinforcing portion 137a and the second reinforcing portion 137b, and therefore, the pull force can be dispersed to the two reinforcing portions 137. Thus, the durability of the reinforcing portion 137 can be improved.

The attachment portion 25 is located on the side opposite to the seating frame body 130 with respect to the first reinforcing portion 137a, and therefore, when the occupant sits on the seat, the occupant is less likely to contact the attachment portion 25, and narrowing of the occupant seating space can be suppressed.

The seatbelt 20 is a four-point seatbelt, and therefore, no belt winder is attached to the side belt 21, and the length of the side belt 21 is constant. That is, even when the occupant moves the seat forward, the length of the side belt 21 does not change. However, the side belt 21 is attached to the support 30A, and therefore, upon forward movement of the seat 13A, the side belt 21 can follow movement of the seat 13A. Thus, excessive tightening of the side portion of the abdomen of the occupant with the side belt 21 can be reduced.

Each of the two right and left side belts 21 is attached to the support 30A, and therefore, upon forward movement of the seat 13A, excessive tightening of the right and left side portions of the abdomen of the occupant with the side belts 21 can be reduced.

According to the above-described vehicle 100A, the side belt 21 of the seatbelt 20 is attached to the support 30A, and therefore, when the occupant moves the seat 13A (seat cushion 13a) forward through the slide adjuster 60, the side belt 21 follows movement of the seat 13A. Thus, upon forward movement of the seat 13A, the side portion of the abdomen of the occupant is less likely to be excessively tightened with the side belt 21, and excessive tightening of the side portion of the abdomen of the occupant can be reduced.

Note that although description of other configurations, features, and effects will be omitted, description of the seat assembly 10 according to the first embodiment can be used in description of the seat assembly 10C according to the second embodiment.

### OTHER EMBODIMENTS

The embodiment has been described above as an example of the technique disclosed in the present application. However, the technique in the present disclosure is not limited to above, and is also applicable to embodiments to which changes, replacements, additions, omissions, etc. are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

For example, the seat assembly 10 includes the front seat assembly (front seat) and the rear seat assembly (rear seat), but may include only the front seat or include three or more rows of seats.

In the above-described first and second embodiments, the seatbelt 20 is the four-point seatbelt, but may be a six-point seatbelt. Specifically, the six-point seatbelt has foot belts corresponding to the thighs in addition to the side belts 21 and the shoulder belts 22.

In the above-described first embodiment, the attachment portion 25 of the side belt 21 is attached to the slide frame 11, but an end portion of the belt portion 24 of the side belt 21 may be directly attached to the slide frame 11.

In the above-described first embodiment, the lift operator 16 is the rod-shaped lever operator, but may be a circular columnar dial operator.

In the above-described first embodiment, the seat assembly 10 has the reclining operator 15 and the lift operator 16, but may have only the reclining operator 15 out of the reclining operator 15 and the lift operator 16.

In the above-described first embodiment, the seat assembly 10 has the reclining adjuster 70 and the lift adjuster 80, but may have only the reclining adjuster 70 out of the reclining adjuster 70 and the lift adjuster 80.

In the above-described first embodiment, the attachment portion 25 is positioned on the vehicle-width outside of the lift adjuster 80 as viewed from above, but is not necessarily positioned on the same line as that of the lift adjuster 80 in the width direction as viewed from above.

In the above-described first embodiment, the left front seat assembly 10 has been described, but needless to say, the technique disclosed here is also applicable to the right front seat assembly 10, the left rear seat assembly 10, and the right rear seat assembly 10.

In the above-described first and second embodiments, the attachment portion 25 of the side belt 21 is attached to the support 30, 30A, but the end portion of the belt portion 24 of the side belt 21 may be directly attached to the support 30, 30A.

In the above-described second embodiment, the reinforcing portion 137 is joined to the back frame 133 and the seat frame 134, but the reinforcing portion 137 may be joined only to one of the back frame 133 or the seat frame 134.

In the above-described second embodiment, the attachment portion 25 is attached to the reinforcing portion 137, but may be attached to the seating frame body 130. Specifically, the attachment portion 25 may be attached only to one of the back frame 133 or the seat frame 134.

In the above-described second embodiment, part of the attachment portion 25 is located higher than the seat frame 134, but the entirety of the attachment portion 25 may be located higher than the seat frame 134 or at least part of the attachment portion 25 may be located lower than the seat frame 134.

In the above-described second embodiment, the attachment portion 25 is located outside the frame of the seating frame body 130, but may be located inside the frame of the seating frame body 130.

In the above-described second embodiment, the attachment portion 25 is fastened to the reinforcing portion 137 with the fastening portion 40, but may be fastened to the reinforcing portion 137 by welding. In this case, the position at which the attachment portion 25 is joined to the reinforcing portion 137 is a position at which the attachment portion 25 is welded to the reinforcing portion 137.

In the above-described second embodiment, the seating frame 13b is joined to the guide 63 with the fastening portion 51, 52, but may be joined to the guide 63 by welding. In this case, the position at which the seating frame 13b is joined to the guide 63 is a position at which the seating frame 13b is welded to the guide 63.

In the above-described second embodiment, the cross member 136 is joined to the seat frame 134 by welding, but may be joined to the seat frame 134 with a fastening portion other than, e.g., the fastening portions 51, 52 or a fastening component other than the fastening portion. In this case, the position at which the cross member 136 is joined to the seat frame 134 is a position at which the cross member 136 is fastened to the seat frame 134 with the fastening portion or the fastening component.

In the above-described second embodiment, the seat assembly 10C does not include the reclining adjuster 70 and the lift adjuster 80 of the first embodiment, but may include at least one of the reclining adjuster 70 or the lift adjuster 80. For example, the back portion 131 and back frame 133 of the seat 13A may tilt back and forth. In this case, a positional relationship between the attachment portion 25 and the reclining operator 15 or the lift operator 16 may be the same as the positional relationship described in the first embodiment, the first modification, or the second modification.

The technique disclosed here may be applied to an off-road vehicle other than the utility vehicles 100, 100A.

### Aspects

The above-described embodiment is a specific example of the following aspects.

### (First Aspect)

The seat assembly 10, 10A, 10B, 10C is the seat assembly 10, 10A, 10B, 10C attached to the vehicle body frame 1, which includes the seat cushion 13a, the support 30, 30A supporting the seat cushion 13a and attached to the vehicle body frame 1 so as to move in the front-rear direction, and the seatbelt 20 having the side belt 21. The side belt 21 is attached to the support 30, 30A.

### (Second Aspect)

In the seat assembly 10C of the first aspect, the support 30A includes the seating frame 13b, and the side belt 21 is attached to the seating frame 13b.

### (Third Aspect)

In the seat assembly 10C of the first or second aspect, the seating frame 13b includes the seating frame body 130 and the reinforcing portion 137 reinforcing the seating frame body 130, the side belt 21 includes the belt portion 24 and the attachment portion 25 connected to the end portion of the belt portion 24, and the attachment portion 25 is attached to the reinforcing portion 137.

### (Fourth Aspect)

The seat assembly 10C of any one of the first to third aspects further includes the rail 62 fixed to the vehicle body frame 1, and the guide 63 attached to the rail 62 so as to move in the front-rear direction. The seating frame 13b is joined to the guide 63, and the attachment portion 25 is joined to the reinforcing portion 137. The position at which the attachment portion 25 is joined to the reinforcing portion 137 is in the vicinity of the position at which the seating frame 13b is joined to the guide 63.

### (Fifth Aspect)

The seat assembly 10C of any one of the first to fourth aspects further includes the rail 62 fixed to the vehicle body frame 1, and the guide 63 attached to the rail 62 so as to move in the front-rear direction. The seating frame 13b is joined to the guide 63, and the attachment portion 25 is joined to the reinforcing portion 137. The position at which the attachment portion 25 is joined to the reinforcing portion 137 and the position at which the seating frame 13b is joined to the guide 63 are in rear of the center position of the seat frame 134 of the seating frame body 130 in the front-rear direction.

### (Sixth Aspect)

In the seat assembly 10C of any one of the first to fifth aspects, the seating frame body 130 includes the seat frame 134 and the cross member 136 joined to the inside of the seat frame 134 and extending in the width direction. The attachment portion 25 is joined to the reinforcing portion 137. The position at which the attachment portion 25 is joined to the reinforcing portion 137 is in the vicinity of the position at which the cross member 136 is joined to the seat frame 134.

### (Seventh Aspect)

In the seat assembly 10C of any one of the first to sixth aspects, the seating frame body 130 includes the seat frame 134 and the cross member 136 joined to the inside of the seat frame 134 and extending in the width direction. The attachment portion 25 is joined to the reinforcing portion 137. The position at which the attachment portion 25 is joined to the reinforcing portion 137 and the position at which the cross member 136 is joined to the seat frame 134 are in rear of the center position of the seat frame 134 in the front-rear direction.

### (Eighth Aspect)

The seat assembly 10C of any one of the first to seventh aspects further includes the rail 62 fixed to the vehicle body frame 1, and the guide 63 attached to the rail 62 so as to move in the front-rear direction. The seating frame 13b is joined to the guide 63, and the attachment portion 25 is joined to the reinforcing portion 137. The seating frame body 130 includes the seat frame 134 and the cross member 136 joined to the inside of the seat frame 134 and extending in the width direction. The position at which the attachment portion 25 is joined to the reinforcing portion 137, the position at which the seating frame 13b is joined to the guide 63, and the position at which the cross member 136 is joined to the seat frame 134 are in rear of the center position of the seat frame 134 in the front-rear direction.

### (Ninth Aspect)

In the seat assembly 10C of any one of the first to eighth aspects, the seating frame body 130 includes the seat frame 134 and the back frame 133 attached to the seat frame 134, and the reinforcing portion 137 is joined to the seat frame 134 and the back frame 133.

### (Tenth Aspect)

In the seat assembly 10C of any one of the first to ninth aspects, the seating frame body 130 includes the seat frame 134, and the attachment portion 25 is located higher than the seat frame 134.

### (Eleventh Aspect)

In the seat assembly 10C of any one of the first to tenth aspects, at least part of the attachment portion 25 is located outside the frame of the seating frame body 130.

### (Twelfth Aspect)

The seat assembly 10C of any one of the first to eleventh aspects further includes the fastening portion 40 fastening the attachment portion 25 to the reinforcing portion 137. The reinforcing portion 137 includes the first reinforcing portion 137a located outside the frame of the seating frame body 130, and the second reinforcing portion 137b located inside the frame of the seating frame body 130. The fastening portion 40 penetrates the first reinforcing portion 137a and the second reinforcing portion 137b, and fastens the attachment portion 25 to the first reinforcing portion 137a and the second reinforcing portion 137b.

### (Thirteenth Aspect)

In the seat assembly 10C of any one of the first to twelfth aspects, the attachment portion 25 is located on the side opposite to the seating frame body 130 with respect to the first reinforcing portion 137a.

### (Fourteenth Aspect)

In the seat assembly 10C of any one of the first to thirteenth aspects, the seatbelt 20 is the four-point seatbelt. The side belt 21 includes the two right and left side belts 21, and the attachment portion 25 includes the two attachment portions 25. The reinforcing portion 137 includes the two reinforcing portions 137 each located on the right and left sides of the seating frame body 130 and reinforcing the seating frame body 130. The two attachment portions 25 are each attached to the two reinforcing portions 137.

### (Fifteenth Aspect)

The utility vehicle 100, 100A (off-road vehicle) includes the vehicle body frame 1, and the seat assembly 10, 10A, 10B, 10C attached to the vehicle body frame 1. The seat assembly 10, 10A, 10B, 10C includes the seat cushion 13a, the support 30, 30A supporting the seat cushion 13a and attached to the vehicle body frame 1 so as to move in the front-rear direction, and the seatbelt 20 having the side belt 21. The side belt 21 is attached to the support 30, 30A.

What is claimed:

1. A seat assembly attached to a vehicle body frame, comprising:
a seat cushion;
a support supporting the seat cushion and attached to the vehicle body frame so as to move in a front-rear direction; and
a seatbelt including a side belt,
wherein the side belt is attached to the support.

2. The seat assembly of claim 1, wherein
the support includes a seating frame, and
the side belt is attached to the seating frame.

3. The seat assembly of claim 2, wherein
the seating frame includes a seating frame body and a reinforcing portion reinforcing the seating frame body,
the side belt includes a belt portion and an attachment portion connected to an end portion of the belt portion, and
the attachment portion is attached to the reinforcing portion.

4. The seat assembly of claim 3, further comprising:
a rail fixed to the vehicle body frame; and
a guide attached to the rail so as to move in the front-rear direction,
wherein the seating frame is joined to the guide, and the attachment portion is joined to the reinforcing portion, and
a position at which the attachment portion is joined to the reinforcing portion is in vicinity of a position at which the seating frame is joined to the guide.

5. The seat assembly of claim 3, further comprising:
a rail fixed to the vehicle body frame; and
a guide attached to the rail so as to move in the front-rear direction,
wherein the seating frame is joined to the guide, and the attachment portion is joined to the reinforcing portion, and
a position at which the attachment portion is joined to the reinforcing portion and a position at which the seating frame is joined to the guide are in rear of a center position of a seat frame of the seating frame body in the front-rear direction.

6. The seat assembly of claim 3, wherein
the seating frame body includes a seat frame and a cross member joined to an inside of the seat frame and extending in a width direction,
the attachment portion is joined to the reinforcing portion, and
a position at which the attachment portion is joined to the reinforcing portion is in vicinity of a position at which the cross member is joined to the seat frame.

7. The seat assembly of claim 3, wherein
the seating frame body includes a seat frame and a cross member joined to an inside of the seat frame and extending in a width direction,
the attachment portion is joined to the reinforcing portion, and
a position at which the attachment portion is joined to the reinforcing portion and a position at which the cross member is joined to the seat frame are in rear of a center position of the seat frame in the front-rear direction.

8. The seat assembly of claim 3, further comprising:
a rail fixed to the vehicle body frame; and
a guide attached to the rail so as to move in the front-rear direction,
wherein the seating frame is joined to the guide, and the attachment portion is joined to the reinforcing portion,
the seating frame body includes a seat frame and a cross member joined to an inside of the seat frame and extending in a width direction, and
a position at which the attachment portion is joined to the reinforcing portion, a position at which the seating frame is joined to the guide, and a position at which the cross member is joined to the seat frame are in rear of a center position of the seat frame in the front-rear direction.

9. The seat assembly of claim 3, wherein
the seating frame body includes a seat frame and a back frame attached to the seat frame, and
the reinforcing portion is joined to the seat frame and the back frame.

10. The seat assembly of claim 3, wherein
the seating frame body includes a seat frame, and
the attachment portion is located higher than the seat frame.

11. The seat assembly of claim 3, wherein
at least part of the attachment portion is located outside a frame of the seating frame body.

12. The seat assembly of claim 3, further comprising:
a fastening portion fastening the attachment portion to the reinforcing portion,
wherein the reinforcing portion includes a first reinforcing portion located outside a frame of the seating frame body, and a second reinforcing portion located inside the frame of the seating frame body, and
the fastening portion penetrates the first reinforcing portion and the second reinforcing portion, and fastens the attachment portion to the first reinforcing portion and the second reinforcing portion.

13. The seat assembly of claim 12, wherein
the attachment portion is located on a side opposite to the seating frame body with respect to the first reinforcing portion.

14. The seat assembly of claim 3, wherein
the seatbelt is a four-point seatbelt, the side belt includes two right and left side belts, and the attachment portion includes two attachment portions,
the reinforcing portion includes two reinforcing portions each located on right and left sides of the seating frame body and reinforcing the seating frame body, and
the two attachment portions are each attached to the two reinforcing portions.

15. An off-road vehicle comprising:
a vehicle body frame; and
a seat assembly attached to the vehicle body frame,
wherein the seat assembly includes
a seat cushion,
a support supporting the seat cushion and attached to the vehicle body frame so as to move in a front-rear direction, and
a seatbelt including a side belt, and
the side belt is attached to the support.
